(19) United States
(12) Patent Application Publication
(10) Pub. No.: US 2018/0056719 A1
(43) Pub. Date: Mar. 1, 2018

(54) HEAVY DUTY TIRE

(71) Applicant: The Goodyear Tire & Rubber Company, Akron, OH (US)

(72) Inventor: Daniel Austin BISHOP, Barberton, OH (US)

(21) Appl. No.: 15/672,332

(22) Filed: Aug. 9, 2017

Related U.S. Application Data
(60) Provisional application No. 62/381,149, filed on Aug. 30, 2016.

(51) Int. Cl. B60C 5/08

(52) U.S. Cl. CPC B60C 5/08; B60C 15/0632

(57) ABSTRACT

A pneumatic tire is described for heavy load and severe conditions. The tire has a carcass with one or more cord reinforced plies and a pair of bead portions. Each bead portion has at least one annular inextensible bead core about which the cord reinforced plies are wrapped. The bead core has a substantially flat bead face joined together with rounded ends on each side of the bead face.

### TECHNICAL FIELD

This invention pertains to heavy duty pneumatic tires such as are commonly used on earthmoving and mining equipment or heavy vehicles.

### BACKGROUND

The present invention relates to tires intended to be fitted to a heavy vehicle, typically in the size ranges of 57 inch radial through 63 inch radial. Although not restricted to this type of application, the tire of the present invention may be used on off highway trucks including dump trucks, rigid frame trucks, large haulage trucks, equipment used for mining, and earthmoving equipment. These off-highway trucks travel across extremely challenging surfaces while typically carrying enormous loads. As a result, the tires on these vehicles are exposed to tremendous forces.

The tires of this sort are typically designed with a bead core in the lower sidewall of the tire that has a round, cross-sectional shape. These tires are usually mounted on wheels that have flat seated rims, so that the surfaces of the rim against which the base of the beads are mounted have a rim taper on the order of 5 degrees with respect to the axial direction. Because the tires are subjected to very high loads, it has become apparent that these tires are subject to wear in the bead region. This type of bead wear may be caused by uneven compression under the bead, resulting in uneven wear due to non-uniform shear stress. It is desired to have an improved tire design to reduce the wear in the bead region of the tire, and to reduce the shear stresses in the bead region of the tire.

### DISCLOSURE OF THE INVENTION

### Definitions

“Aspect ratio” of the tire means the ratio of its section height (SH) to its section width (SW);

“Axial” and “axially” mean lines or directions that are parallel to the axis of rotation of the tire;

“Bead” means that part of the tire comprising an annular tensile member wrapped by ply cords and shaped, with or without other reinforcement elements such as flippers, chippers, apexes, toe guards and chafers, to fit the design rim;

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire;

“Bias Ply Tire” means that the reinforcing cords in the carcass ply extend diagonally across the tire from bead-to-bead at about a 25-50° angle with respect to the equatorial plane of the tire, the ply cords running at opposite angles in alternate layers;

“Carcass” means the tire structure apart from the belt structure, tread, under tread, and sidewall rubber over the plies, but including the beads;

“Circumferential” means lines or directions extending along the perimeter of the surface of the annular tread perpendicular to the axial direction;

“Chafers” refers to narrow strips of material placed around the outside of the bead to protect cord plies from the rim, distribute flexing above the rim, and to seal the tire;

“Chippers” means a reinforcement structure located in the bead portion of the tire;

“Cord” means one of the reinforcement strands of which the plies in the tire are comprised;

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Equatorial plane (EP)” means the plane perpendicular to the tire's axis of rotation and passing through the center of its tread;

“Innerliner” means the layer or layers of elastomer or other material that form the inside surface of a tubeless tire and that contain the inflating fluid within the tire;

“Normal rim diameter” means the average diameter of the rim flange at the location where the bead portion of the tire seats;

“Normal inflation pressure” refers to the specific design inflation pressure and load assigned by the appropriate standards organization for the service condition for the tire;

“Normal load” refers to the specific design inflation pressure and load assigned by the appropriate standards organization for the service condition for the tire;

“Ply” means a continuous layer of rubber-coated parallel cords;

“Radial” means a direction that intersects the axis of rotation and is perpendicular thereto;

“Radial-ply tire” means belted or circumferentially-restricted pneumatic tire in which the ply cords which extend from the bead to bead are laid at cord angles between 65 degrees and 90 degrees with respect to the equatorial plane of the tire;

“Section height” (SH) means the radial distance from the nominal rim diameter to the outer diameter of the tire at its equatorial plane; and,

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Turn-up pad” means a strip of elastomer located between the chafer and the turnup end of the ply in the lower sidewall of the tire near the bead general area.

### BRIEF DESCRIPTION OF DRAWINGS

The invention may take physical form and certain parts and arrangements of parts, several preferred embodiments of which will be described in detail in this specification and illustrated in the accompanying drawings which form a part whereof and wherein:

FIG. 1 is a cross-sectional view of one half of the tire shown in FIG. 1 shown mounted on a rim;

FIG. 2 is a cross-sectional view illustrating a lower sidewall of a heavy-duty tire according to a first embodiment of the invention;

FIG. 3 is an enlarged cross-sectional view of the bead core of the present invention;

FIG. 4 is a cross-sectional view illustrating a lower sidewall of a heavy-duty tire according to a second embodiment of the invention;

FIG. 5 is a cross-sectional view illustrating a lower sidewall of a heavy-duty tire according to a third embodiment of the invention;

### DETAILED DESCRIPTION OF THE INVENTION

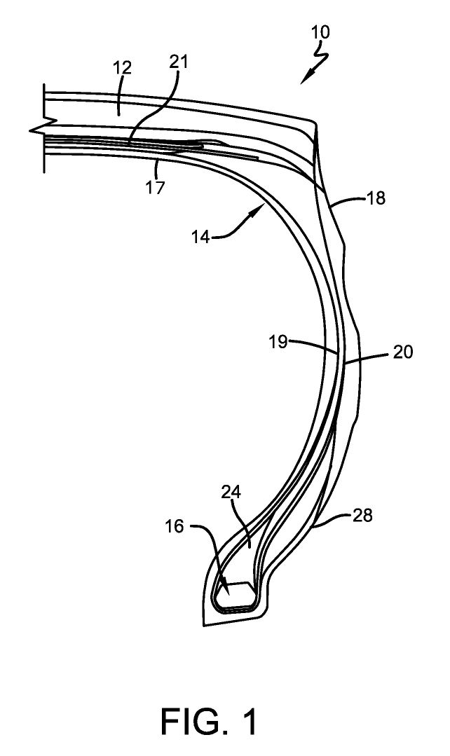

With reference to FIG. 1, a cross-sectional view of one half of a lower sidewall region of a tire of the present invention 10 is illustrated. The tire 10 has a carcass 14 which includes a crown region having a radially outer tread 12 disposed over the crown region of the carcass 14. The outer surface of the tread may further include a plurality of lands and grooves or a plurality of tread blocks and grooves, as commonly known to those skilled in the art. The carcass further includes an optional inner liner 17 that covers the entire interior facing surface of the tire carcass and serves to hold the air or gas mixture that is used to inflate the tire. The inner liner of the tire is typically made of butyl rubber. The carcass 14 further includes a pair of tire sidewalls 18 which extend radially inward from the outer radial surface of the of the tire carcass, terminating in the vicinity of a pair of inextensible annular tensile members or bead cores 16.

The carcass further includes one or more steel cord reinforced plies 19 wrapped about each bead core 16 forming a turnup portion 20, more preferably an envelope turnup. The portion of the ply which extends from the crown towards the bead and is axially inwards of the bead is referred to as the down portion of the ply or down ply, while the portion of the ply which extends radially and axially outwards from the bead is referred to as the up ply or turnup portion. The one or more plies 19 are oriented in the radial direction. Disposed radially outwardly of the ply 19 in the crown area of the tire is a steel reinforced belt package 21 formed of two or more belts. A pair of sidewalls 18 extend radially inward from the radially outer tread 12 to the bead area. Located radially outward of the bead core 16 is an elastomeric apex 24. The apex as shown may have a triangular cross-sectional shape. Wrapped around the bead core 16 is an optional flipper (not shown). The flipper is preferably located between the bead core 16 and the carcass ply 19. Located on the axially inner edge of the bead area is a chafer 28.

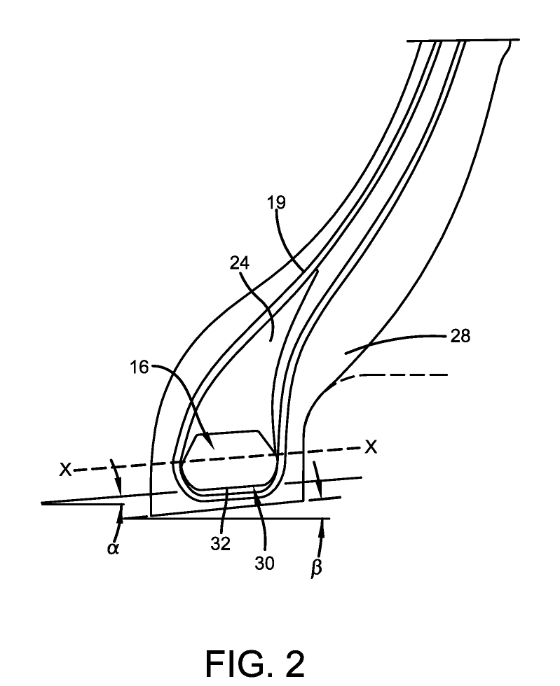

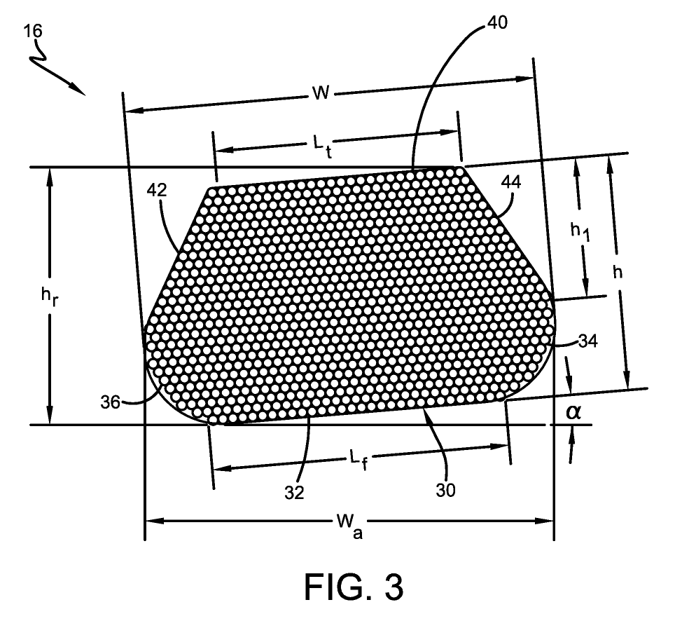

As shown in FIG. 2, each annular bead core 16 has an asymmetrical cross sectional shape, as the bead core 16 is not symmetrical about an axis X-X. The annular bead core as shown in FIG. 3 has a lower radially inner surface or bead face 30 that has a substantially flat portion 32. The bead face 30 is oriented at an angle α that is preferably greater than the taper angle β of the rim flange, which is typically 5 degrees. The angle α is preferably in the range of 4 to 9 degrees, more preferably in the range of 5 to 8 degrees. The bead face 30 preferably has a flat surface Lf having a length in the range of 2.5 to 3.25 inches, and more preferably in the range of 2.75 inches to 3 inches. The bead face 30 has angled shoulders 34,36 on each side of the bead face that are rounded. The radius of curvature of the angled shoulders is in the range of 0.5 to 0.9 inches, and more preferably, 0.6 to 0.8 inches. The bead core 16 has a maximum bead width W in the range of 3.5 to 4.5, and more preferably 3.75 to 4.3. The bead core 16 has an upper surface 40 that may be parallel to the bead face 30. The upper surface 40 is preferably flat. The upper surface is joined by an axially-inward and axially-outward angled surfaces 42, 44. The upper surface 40 together with the angled surfaces 42, 44 are arranged to resemble the upper half of a hexagonal bead core. In other words, the angled surfaces 42,44 make a γ angle 120 degrees with the upper surface.

Because the bead core 16 is rotated an angle α, the radial height hr of the bead core as measured from the radially outermost point to the radially innermost point of the bead core cross-section, is in the range of 2 to 3 inches, and more preferably in the range of 2.3 to 2.7 inches. The axial width Wa is in the range of 3.5 to 4.5 inches, and more preferably in the range of 3.8 to 4.3 inches. The ratio of the bead height H to the width W is in the range of 0.4 to 0.8, and more preferably in the range of 0.4 to 0.7, and more preferably 0.5 to 0.6.

The bead core 16 is formed from a plurality of wound bead wires, each wire having a size in the range of 2-4 mm.

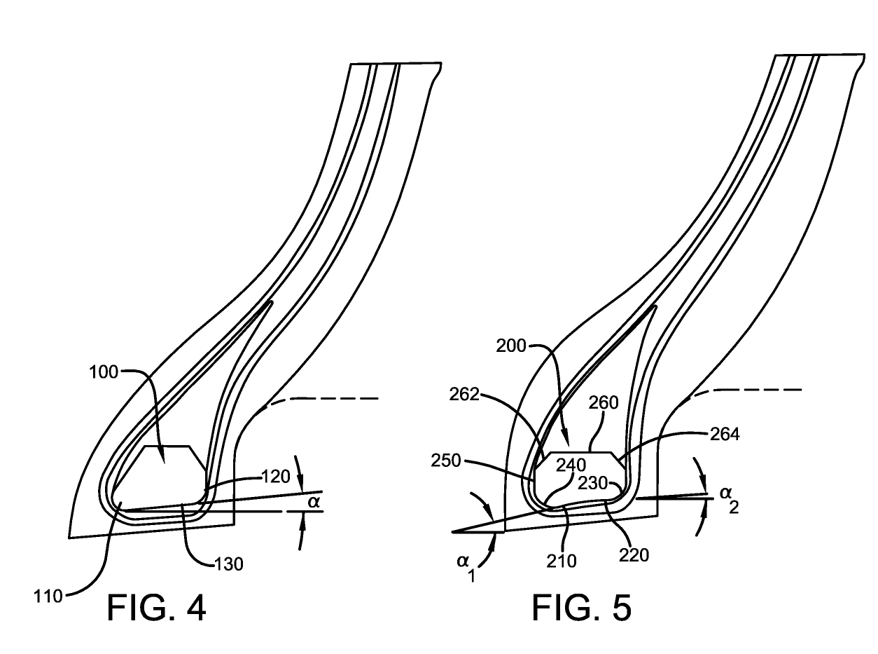

FIG. 4 illustrates an alternate embodiment of the bead core 100 of the present invention. The bead core 100 has an enlarged toe 110 and a rounded heel 120. The bead core 100 has a flat lower bead face 130. The extended enlarged toe 110 allows the ply turndown angle to be increased so that it is closer to its deflected shape. The flat lower bead face 130 has a length of 2.5 inches. The flat lower bead face 130 is angled at an angle α in the range of 4-6 degrees. The width bead core is in the range of 1.5*H to 2*H. FIG. 5 illustrates a third embodiment of the bead core 200 of the present invention.

The bead core 200 has a first flat bead face 210 joined with a second flat bead face 220. The first flat bead face 210 is angled at an angle α1 in the range of 10-14 degrees, while the second flat bead face 220 is angled at an angle α2 in the range of 4-6 degrees. Thus, the bead face 210,220 has a dual taper not equal to the rim taper. The bead core 200 has rounded edges 230,240. Axially inner rounded edge 240 transitions to a radial edge 250. The bead core width is in the range of 1.5 to 2 times the bead height. The bead core 200 has an upper surface 260 that may be parallel to one of the bead faces 210,220. The upper surface 260 is preferably flat. The upper surface is joined by an axially-inward and axially-outward angled surfaces 262, 264. The upper surface 260 together with the angled surfaces 262, 264 are arranged to resemble the upper half of a hexagonal bead core. In other words, the angled surfaces 262, 264 make a γ angle 120 degrees with the upper surface 260.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising a carcass, the carcass having one or more cord reinforced plies and a pair of bead portions, each bead portion having at least one annular inextensible bead core about which the cord reinforced plies are wrapped, a tread and a belt reinforcing structure disposed radially outward of the carcass, the bead portion further comprising an apex which extends radially outward of the bead core, and a chafer, the tire further comprising a bead core having a substantially flat bead face joined together with rounded ends on each side of the bead face.

2. The pneumatic tire of claim 1 wherein the bead core is not symmetrical about a radial plane that extends through the centerpoint of the bead core.

3. The pneumatic tire of claim 1 wherein the bead core is not symmetrical about any plane that extends through the centerpoint of the bead core.

4. The pneumatic tire of claim 1 wherein the bead core is symmetrical about an XX plane that extends through the centerpoint of the bead core and is perpendicular to a radial plane.

5. The pneumatic tire of claim 1 wherein the bead core has a bead face oriented at an angle α that is greater than the taper angle β of the rim flange.

6. The pneumatic tire of claim 1 wherein the bead core has a bead face oriented at an angle α in the range of 6 to 8 degrees.

7. The pneumatic tire of claim 1 wherein the bead core has a maximum bead width W in the range of 3.5 to 4.5 inches.

8. The pneumatic tire of claim 1 wherein the bead core has a maximum bead width W in the range of 3.75 to 4.3 inches.

9. The pneumatic tire of claim 1 wherein the bead face has angled shoulders disposed on each side of the bead face, wherein each of the shoulders are rounded.

10. The pneumatic tire of claim 9 wherein the radius of curvature of the angled shoulders is in the range of 0.5 to 0.9.

11. The pneumatic tire of claim 1 wherein the bead core has a ratio of the bead height H to the bead width W is in the range of 0.4 to 0.8.

12. The pneumatic tire of claim 1 wherein the bead core has a ratio of the bead height H to the bead width W is in the range of 0.4 to 0.7.

13. The pneumatic tire of claim 1 wherein the bead core has a ratio of the bead height H to the bead width W is in the range of 0.5 to 0.6.

14. The pneumatic tire of claim 1 wherein the bead core has an axially inward extended toe.

15. The pneumatic tire of claim 1 wherein the bead core has a bead face formed of a dual taper surface.

16. The pneumatic tire of claim 1 wherein the bead core has a concave bead face.
